(19) United States
(12) Patent Application Publication
(10) Pub. No.: US 2006/0166659 A1
(43) Pub. Date: Jul. 27, 2006

(54) Mobile telephone device

(76) Inventors: Antonie Hendrik Jacobus Wiese, Ashmore (AU); Alvaro Bernardo Tafur Castillo, Bedfordview (ZA)

Correspondence Address: SHERIDAN ROSS PC, 1560 BROADWAY, SUITE 1200, DENVER, CO, 80202, US

(21) Appl. No.: 10/521,052

(22) PCT Filed: Jan. 7, 2003
(86) PCT No.: PCT/AU03/00007

§ 371 Date: Nov. 4, 2005

(30) Foreign Application Priority Data
Jul. 11, 2002 (ZA) 2002/5564

(51) Int. Cl. H04M 3/00

(52) U.S. Cl. 455/418; 455/73

(57) ABSTRACT

The present invention relates to a mobile telephone device (30) including a single transceiver (33) for connecting the telephone device to a mobile telephone network and a controller (58) coupled to the transceiver, the controller operative to place the mobile telephone device in either a telephone condition thereby allowing a user to selectively connect to the mobile telephone network or in response to receiving an alarm signal, an alarm condition to connect the transceiver to the mobile telephone network and thereby notify a predetermined terminal of the receipt of the alarm signal.

### FIELD OF THE INVENTION

This invention relates to mobile or cellular telephones. In particular, the invention relates to a communication device utilising mobile cellular networks for installation in a vehicle or other area, which device may operate both as a telephone and as component of a security system.

### BACKGROUND OF THE INVENTION

Communications devices which utilise mobile or cellular infrastructure include portable handsets for personal use and, in the case of vehicles, more powerful telephone units and associated antennas permanently installed in a vehicle. Vehicle telephone installations are typically arranged for hands-free use, to avoid potential distractions when operating the vehicle. In some instances, vehicular telephone installations may merely interface a personal handset with hands-free equipment including a microphone and speaker installed in the vehicle.

One particular use of mobile telephone networks is in the area of security, for example in vehicle security applications. One type of vehicle security system that may be installed in a vehicle incorporates a specially adapted telephone transceiver enabling communication with external facilities. The telephone transceiver is connected to a security control unit which coordinates the vehicle's security detectors and response units. Upon the detection of unauthorised activity by the sensors, a signal is sent from the control unit to the internal transceiver, whereupon a call is placed to a predetermined number, such as the number of the owner's mobile phone, a security monitoring service or to the police. The call may carry data specifying the identity of the vehicle and possibly its location.

It will be realised in vehicular applications, where a security system with external communications facility is provided and a mobile telephone installation is provided, there may well be duplication of hardware. In particular it will be realised that there is duplication of the telephone transceiver, which generally accounts for around 80% of the capital cost of a mobile telephone for example.

Accordingly, it would be advantageous for a communications device to be devised that could be used to both make and receive calls in a telephone mode and is also adapted to provide communications as part of a security system.

### SUMMARY OF THE INVENTION

According to a first aspect of the present invention there is provided a mobile telephone device including:

a single transceiver for connecting the mobile telephone device to a mobile telephone network; and

a controller coupled to the transceiver, the controller operative to place the mobile telephone device in either:
a telephone condition thereby allowing a user to selectively connect to the mobile telephone network; or
in response to receiving an alarm signal, an alarm condition to connect the transceiver to the mobile telephone network and thereby notify a predetermined terminal of the receipt of the alarm signal.

According to a second aspect of the present invention there is provided a mobile telephone device including:
a single transceiver for connecting the telephone device to a mobile telephone; and
a controller coupled to the transceiver, the controller operative to place the mobile telephone device in either:
   a telephone condition thereby allowing a user to selectively connect to the mobile telephone network; or
   in response to receiving an alarm signal, an alarm condition to connect the transceiver to the mobile telephone network,
the controller having a security subscriber identification module for use in connection to the mobile telephone network when the mobile telephone device is in the alarm condition and a user subscriber identification module for use in connection to the mobile telephone network when the mobile telephone device is in the telephone condition.

Each subscriber identification module enables a provider of the mobile telephone network to identify a particular account to which any telephone call made via the network by use of the identification module is to be charged, the user subscriber identification module and the security subscriber identification module being for identifying different accounts. Each subscriber identification module may include a computer readable memory device, preferably comprising electronic circuitry, the memory device having information stored thereon for permitting identification of the associated account. Conveniently, each identification module may be a conventional SIM-card.

The user subscriber identification module (SIM) may be one of a pair of subscriber identification modules both of which identify the same account, with said account being a different account from that identified by the security subscriber identification module. Usually, such twin-call SIM-cards are used to enable a user to charge the same account for calls made from a mobile phone carried by the user and calls made from a telephone installed in the user's vehicle, one of the twin-call SIM-cards being located in the vehicle telephone, and the other twin-call SIM-card being located in the user's mobile telephone. In usual operation, the user can select which of the twin-call SIM-cards to use, depending on the user's location. It is, however, a disadvantage of such a conventional system that the twin-call SIM-card in the vehicle cannot connect, via the network, to the twin-call SIM-card in the user's mobile telephone.

The user SIM-card and the security SIM-card may both be located in the mobile telephone device in the form of a mobile telephone control unit for installation in the protected area, the telephone unit including a conventional GSM transceiver module and a switch for, in use, switching between connection of the GSM transceiver module to the user SIM-card and connection of the GSM transceiver module to the security SIM-card.

The protected area may be a vehicle, wherein the switch can be arranged to switch the mobile telephone device to the alarm condition in response to switching off of the vehicle and to switch the mobile telephone device to the telephone condition in response to ignition of the vehicle.

The mobile telephone device may thus be in the form of a mobile telephone control unit which forms part of a mobile telephone for installation in a motor vehicle.

The mobile telephone device may be arranged to send an alarm message to the user's mobile telephone, using the security SIM-card, in response to the generation of an alarm signal. It should be appreciated that the user's mobile phone will typically operate with a twin-call SIM card identifying the same account as the user SIM-card in the telephone device. The alarm message may be a text message, such as an SMS-message, or it may be a voice call.

The security system may include a tracking device, such as a satellite tracking device or a global positioning unit, in connection with the mobile telephone to provide a position signal thereto, the alarm message including information representative of the position of the vehicle.

The mobile telephone in the vehicle may be substantially hidden from view. By “hidden from view” is meant that, when a person is seated in a driver's seat of the vehicle, no major component of the mobile telephone, such as a key-pad, is visible to the naked eye. The mobile telephone may thus have no permanently installed keypad, or the keypad may be operable between a hidden condition in which the keypad is hidden from view, and an operative position, in which the key pad is visible and is readily accessible to a driver of the vehicle.

The mobile telephone may, however, include a disconnectably connectable headset comprising a microphone-and-speaker system. Instead, or in addition, the mobile telephone may include a speaker in the form of an ear-piece for location in an ear of a driver of the vehicle, the ear-piece being permanently installed in the vehicle.

Thus, the mobile telephone may have no permanently installed manually operable input device, such as a key-pad, for providing a dial-up facility to the user. The mobile telephone may, however, have a dial-up system for permitting a user to control the telephone control unit by use of a conventional mobile telephone, and to connect the mobile telephone to the telephone network. The dial-up system may comprise a device for receiving audio signals from a conventional mobile telephone, the audio signals being generated in response to the pressing of keys on a keypad of the mobile telephone, and for converting the audio signals to electronic command signals for the mobile telephone, in accordance with, for instance, standard protocols such as DTMF.

The mobile telephone may include a cordless keypad for interfacing with a control unit of the telephone via wireless communication signals, such as infra-red communication signals.

The mobile telephone may include a user operable connection switch for connecting the telephone to the network, for instance, for answering a call received via the network, or for disconnecting from the network, the connection switch being hidden from view.

The security system may be a residential security system for installation in a residence or other building, and the security system may include a portable remote control panic device for producing a wireless alarm signal when activated by a user.

The invention also provides a mobile telephone for forming part of a security system as described above.

The invention extends to a mobile telephone for installation in a vehicle such that the telephone is substantially hidden from view, as described above.

The invention further extends to a vehicle which includes the security system, or the mobile telephone, as described above.

According to another aspect of the invention there is provided a security system for protection of an area, the system including:
an alarm arrangement for detecting unauthorised activity in respect of the protected area and for generating an alarm signal in response to detection of the unauthorised activity; and
a mobile telephone device connected to the alarm arrangement, the mobile telephone device being operable in an alarm condition to connect to a mobile telephone network and notify a predetermined terminal of the generation of the alarm signal and in a telephone condition to allow a user to connect to the mobile telephone network.

### BRIEF DESCRIPTION OF THE DRAWINGS

The invention will now be further described, by way of example, with reference to the accompanying diagrammatic drawings, in which:
FIG. 1 shows, schematically, part of a mobile telephone installed in a vehicle, the mobile telephone being for co-operation with an alarm arrangement installed in the vehicle to form a security system.
FIG. 2 shows, schematically, a further part of the telephone and the security system of FIG. 1;
FIG. 3 is a schematic block diagram of the security system of FIGS. 1 and 2;
FIG. 4 shows, schematically, a security system installed in a building; and
FIG. 5 shows a schematic block diagram of a further embodiment of a security system installed in a vehicle.

### DETAILED DESCRIPTION OF THE PREFERRED EMBODIMENTS

In FIGS. 1 to 3 of the drawings, reference numeral 10 generally indicates a security system in accordance with the invention, the security system 10 being installed in a motor vehicle (not shown). The security system 10 includes an alarm arrangement 12 (shown in FIG. 2) for detecting unauthorised activity such as tampering with or unauthorised entry into the vehicle.

In conventional fashion, the alarm arrangement 12 has an alarm control unit 14 which is connected by electrical relays to a series of detectors for measuring a plurality of parameters which may indicate potential tampering with the vehicle. In this example, the detectors include: vehicle door indicators 15 for detecting the status of the doors of the vehicle; an ignition detector 16 for detecting activation of ignition while the alarm arrangement 12 is armed; a motion detector 17 for detecting motion in a cabin of the vehicle while the alarm arrangement 12 is armed; a low battery detector 18 for detecting when the voltage of the vehicle's main battery 19 is below a predetermined level; and a motion detector 20 for detecting movement of the vehicle relative to the ground, while the alarm is armed.

The alarm control unit 14 is also, in conventional fashion, connected by suitable relays to response units for automatically responding to detection of tampering with the vehicle, inter alia to immobilize the vehicle, the response units including fuel pump cut-offs 21, ignition cut-offs 22, indicator light flashers 23, and an alarm siren 13. The alarm control unit 14 is powered by the battery 19 of the vehicle, and is grounded, at 24.

The system 10 also includes a remote control unit 125 for locking the vehicle, at 25, or unlocking the vehicle, at 26, as well as for arming the alarm, at 27, or disarming the alarm, at 28. The remote control unit 125 is controlled by a portable remote control 29, which communicates with the remote control unit 125 via a wireless infra-red signal, in conventional fashion.

The security system 10 includes a mobile telephone 30 (shown in FIGS. 1 and 3) which operates on the GSM-standard, the mobile telephone 30 being permanently installed in the vehicle. In some cases the mobile telephone 30 may be in the form of a retro-fitted kit, and in others installed by a vehicle maker during manufacture. The telephone 30 of the embodiment includes a mobile telephone device in the form of a mobile telephone control unit 31 which is connected, via a master data bus 32 to the alarm unit 14. In use, when tampering with the vehicle is detected by the alarm arrangement 12, an alarm signal is sent from the alarm control unit 14 to the telephone unit 31, via data bus 32.

The telephone unit 31 houses a GSM transceiver module 33 for effecting connection to a GSM-network (not shown), the module 33 being connected to an antenna 34 which is mounted on the vehicle. It will be realised that transceiver modules for other mobile telephone systems, such as CDMA, GPRS and the like may alternatively be employed.

The telephone unit 31 also provides two SIM-card sockets 36, 38 for removably receiving GSM subscriber identification modules in the form of conventional SIM-cards. A user SIM-card 37 is located in SlM-card socket 36, and a security SIM-card 39 is located in SIM-card socket 38. In certain countries, depending on the mobile telephone network operators, the telephone unit 31 will have only one socket for removable receiving a single subscriber identification module that performs the function of the user SIM-card 37 and the security SIM-card 39 as is detailed further below.

The user SIM-card 37 is a so called “twin-all” SIM-card, which means that it is one of a pair of SIM-cards which identify the same subscriber account when a call is made via a GSM network provided by an associated mobile telephone network provider (not shown). The other twin-call SlM-card (not shown) of the pair of twin-call SIM-cards is located in a mobile telephone (not shown) which is carried on the person of a user (not shown) of the vehicle.

The security SIM-card 39 is associated with a subscriber account different from the subscriber account with which the twin-call SIM-cards are associated. Where there is a single SIM-card that performs the functions of the security SIM-card and the user SIM-card, the single card will have its own unique number that differs from the number of the mobile telephone that is carried on the person of the user.

The telephone unit 31 includes a switch 40 for switching connection of the GSM transceiver module 33 between the user SIM-card 37 and the security SIM-card 39. In this example, the switch 40 is arranged to connect the GSM transceiver module 33 to the twin-call SIM-card 37 when the ignition of the vehicle is switched on or when the alarm is disarmed, and to connect the security SIM-card 39 to the GSM transceiver module 33 in response to switching off of the ignition of the vehicle or arming of the alarm. The telephone unit 31 provides an indicating arrangement for indicating which of the SIM-cards 37, 39 is connected to the GSM transceiver module 33, in this case being a pair of indicating lights 35. Thus, the telephone unit 31 is operable in a telephone condition, wherein the GSM transceiver module 33 is in connection with the user SIM-card 37, and in a security condition, in which the GSM transceiver module 33 is in connection with the security SIM-card 39.

Alternatively, where there is a single SIM-card associated with a single subscriber account the switch is arranged to notify a predetermined terminal of the generation of the alarm signal by the alarm arrangement. This notification is affected via the SIM-card when the ignition of the vehicle is switched off or the alarm is armed and the terminal contacted could, for example, be the user's mobile telephone (not shown) wherein the notification could be by way of text message or a voice call. For receiving telephone calls in the vehicle the user will divert or forward his mobile hand set to the SIM-card in the telephone unit. Should the user receive a telephone call whilst the mobile telephone device is in the alarm condition, the mobile telephone device will automatically forward the call to the user's voice mailbox of his mobile handset. Again, the telephone unit 31 is operable in a telephone condition, wherein the GSM transceiver module 33 is in connection with the SIM-card for making and receiving calls via the mobile telephone network, and in a security condition, in which the GSM transceiver module 33 is arranged to notify a predetermined terminal of the generation of the alarm signal by the alarm arrangement.

The telephone unit 31 is connected to an auxiliary power supply in the form of a 12V back-up battery 41, for powering the telephone unit 31 and the alarm control unit 14 in the case of failure of the main battery 19.

The telephone 30 includes a hands-free microphone 42 and a speaker 44 for permitting a user to use the telephone 30 in a hands-free manner, when the user is seated in the vehicle, the microphone 42 and speaker 44 being connected to the telephone unit 31 via bi-directional amplifier 46. The microphone 42 and amplifier 46 is integrated into the dashboard or console (not shown) of the vehicle, so that it is substantially hidden from view. Naturally, the speaker 44 may be provided by an existing conventional speaker system connected to a radio system installed in the vehicle. The kit 30 additionally provides a socket 43 for connection of the amplifier 46 to a conventional hands-free headset 45. In the usual manner, a vehicle radio mute relay 54 is provided for automatically muting the radio system of the vehicle when the telephone 30 is in operation.

Although not illustrated, the kit 30 can include a private or personal speaker housed in an ear-piece which is shaped and dimensioned for insertion into an ear of a driver of the vehicle. This ear-piece is permanently installed in the vehicle, to form a permanent part of the kit 30. The kit 30 will then include a user operable control for switching between a general mode in which the vehicle radio speakers are used for sound production, and a personal or private mode in which the radio speakers are muted, and the audio of the telephone 30 is produced exclusively through the ear-piece.

The telephone 30 is also provided with a connection switch in the form of a push button 48, which provides an answer/hang-up function, for permitting the user to connect the GSM transceiver module 33 to the network in response to the reception of a telephone call via the network, and to disconnect from the network to end the call. This button 48 is hidden from view, in this case being located behind a steering column (not shown) of the vehicle.

A conventional key-pad 50 is connected to the telephone unit 31, for providing control over the telephone 30 and permitting dial-up by the user. However, it should be appreciated that this permanently installed keypad 50 is optional, and if it is desired that the telephone 30 should be substantially hidden from view, this key-pad 50 will be omitted. To permit control of the telephone unit 31, and to provide a dial-up facility, when the key-pad 50 is omitted, the telephone 30 includes DTMF tone decoder 52, for decoding audio signals generated by a conventional mobile telephone in response to pressing of the keys of the mobile phone. The decoder 52 decodes these audio signals and converts them into command signals for controlling the telephone unit 31. A cradle (not shown) may be provided for holding the mobile telephone, the cradle being located adjacent the microphone 42, so that a user can, in use, place the mobile telephone in the cradle and press the desired keys on the mobile telephone, the microphone relaying the audio signals to the decoder 52. The kit 30 thus enables a conventional mobile telephone to serve as a removable key-pad for the telephone 30.

Although not shown in the drawings, the kit 30 can be configured to have a cordless or wireless key-pad which communicates with the control unit 31 via wireless infra-red signals, in a manner similar to the operation of remote control devices. This cordless key-pad could be hidden from view when not in use, for instance being located in a cubby hole of the vehicle, or being located in a recess in the dashboard, the recess being openably closed by a closure member in the form of a hingedly displaceable flap.

The user-operable peripherals of the telephone 30, such as the microphone 42, speaker 44, key-pad 50, and connection switch 48 are connected to the telephone unit via a telephone unit interface 56.

The telephone unit 31 is also in connection with an electronic processor in the form of a central processing unit (CPU) 58 of the vehicle, the CPU being provided, in conventional fashion, with sufficient random access memory (RAM) 60 and an audio module 62. The CPU 58 is programmed to govern the functioning of the alarm arrangement 12, which is also connected to the CPU 58, and the telephone 30.

In use, the telephone 30 functions in a manner similar to a conventional vehicle telephone system when the user is located in the vehicle. The GSM transceiver module 33 can connect to the GSM network through the user SIM card 37, as the other twin call SlM-card in the user's mobile telephone will not be in use. However, when the vehicle is switched off and the alarm arrangement 12 is armed, the switch 40 automatically switches the GSM transceiver module 33 into connection with the security SIM-card 39. In the event of an alarm signal being generated by the alarm arrangement 12, the telephone 30 automatically connects to the GSM-network, through the security SIM-card 39, and sends an SMS or voice message to the user's mobile telephone, which operates with the twin-call SIM-card identical to the user SIM-card 37. The SMS message contains an alarm message notifying the user of the detection of unauthorised tampering with the vehicle. The sending of this SMS message is in addition to the usual responses to tripping of the alarm, such as wailing of the siren, flashing of the vehicle's indicators, and immobilisation of the vehicle.

The control unit 31 has a user operable mode switch 98 for switching the control unit 31 between a house mode, in which the unit 31 can form part of a security system for a building such as a house, and a vehicle mode, in which the unit 31 is configured to form part of a vehicle security system, as described with reference to FIGS. 1 to 3.

In FIG. 4 of the drawings, reference numeral 70 generally indicates a further embodiment of a security system in accordance with the invention, the security system 70 being for protection of a building, in this case a house (not shown). Unless otherwise indicated, like reference numerals indicate like parts in FIGS. 1 to 3 and FIG. 4.

The system 70 includes a house alarm system 12 which includes an alarm control unit 14 which is connected to a telephone control unit 31 identical to the telephone control unit 31 described with reference to FIGS. 1 to 3. The alarm control unit 14 is powered by a mains power supply 72, although it is also connected to an auxiliary power supply in the form of a 12V battery of electrochemical cells. The control unit 14 is also in connection with a gate opener 74, auxiliary sensors 76 for sensing violation of a perimeter of the house, a light switch 78 for controlling outdoor lights (not shown) of the house, and an alarm siren 80. Provision is also made for arming, at 82, the alarm arrangement 12, and for disarming, at 84, the alarm arrangement 12.

The alarm arrangement 12 includes a portable remote transmitter 86 which includes a panic button 88, the transmitter 86 being arranged to transmit a wireless panic signal in response to pressing of the panic button 88. A receiver 90 is responsive to the panic signal to activate the alarm unit 14 for generation of an alarm signal.

The telephone unit 31 is connected to a wall-mounted interface unit 92 which incorporates a microphone 42, speaker 44, and key-pad 50.

In use, the system 70 functions as a telephone, permitting an occupant of the house to make and receive telephone calls via the GSM network, the wall-mounted interface unit 92 providing a hands-free interface facility. As before, such conventional telephone calls are routed through the user SIM-card 37, which is a twin call SIM-card.

However, when the alarm is triggered, the telephone unit 31 automatically makes a call to the user's mobile phone, using the security SIM-card. The system 70 can be configured additionally to make calls to appropriate emergency response units. A user can carry the remote transmitter 86 on the user's person, so that, in the event of the user being surprised by an intruder, or in the case of an emergency, the user can press the panic button 88 to trigger the alarm and cause transmission of the alarm message by the control unit 31.

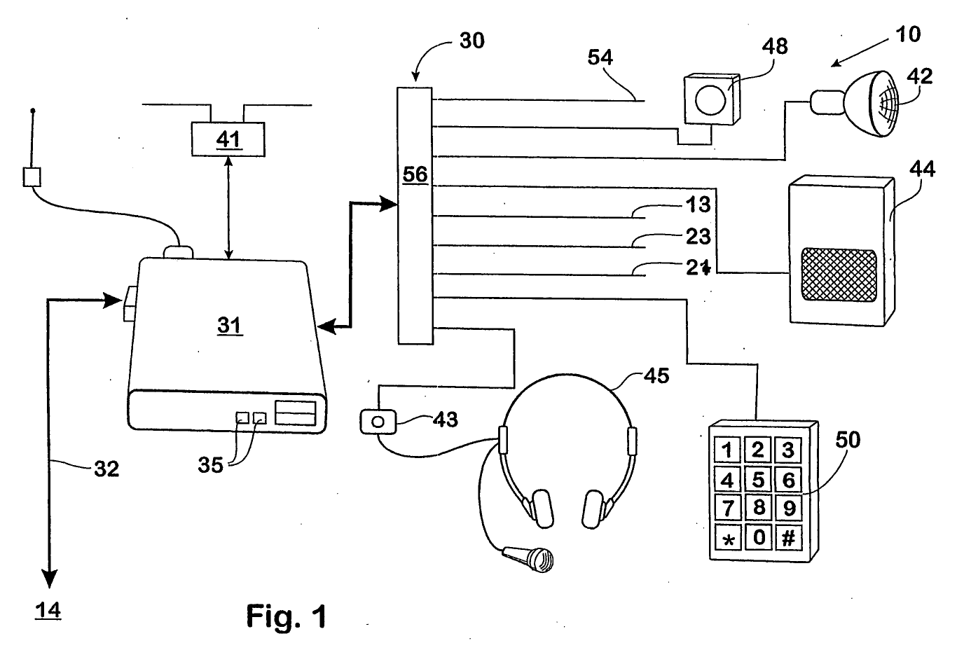

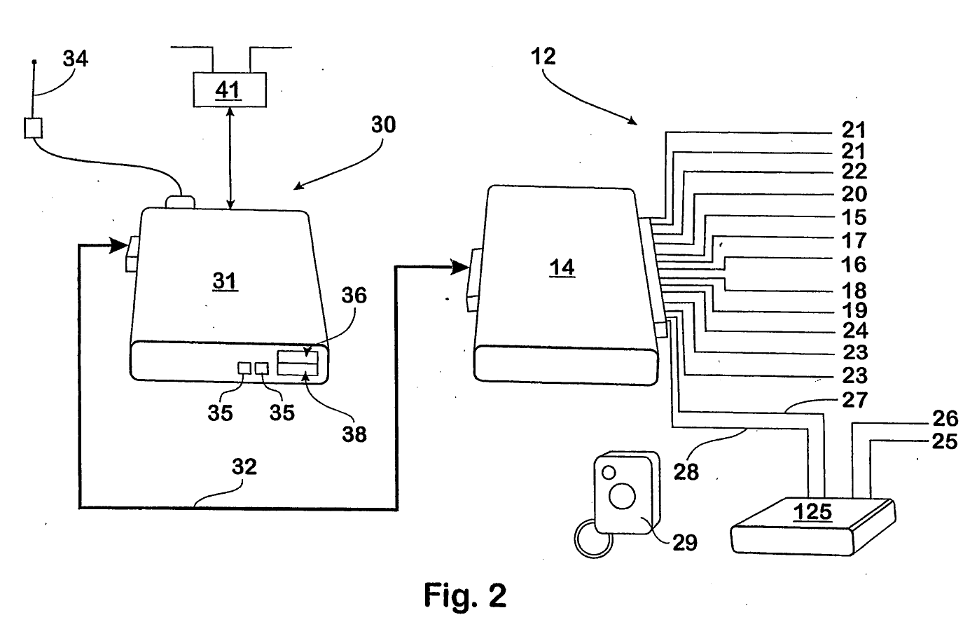

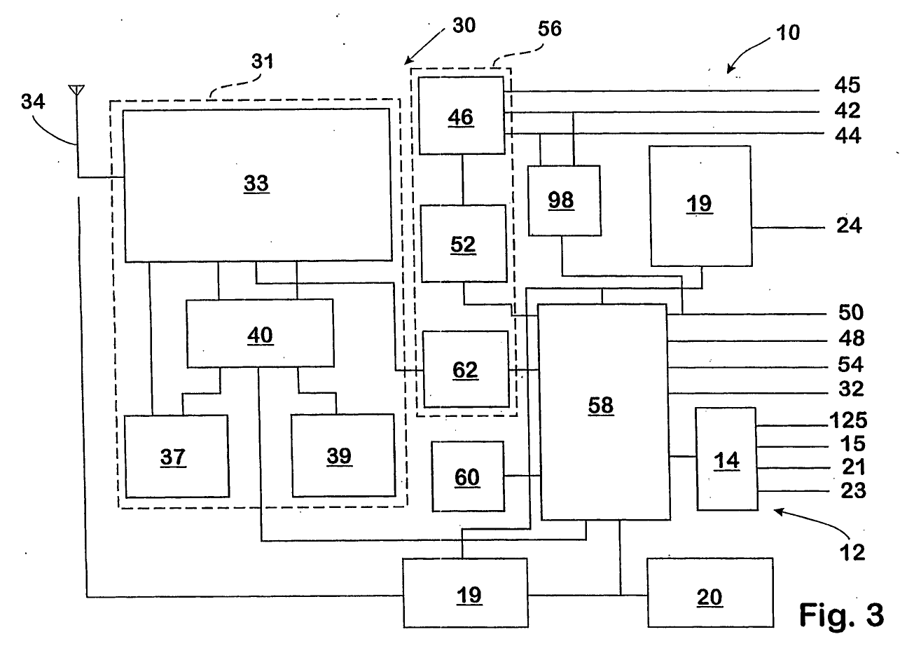

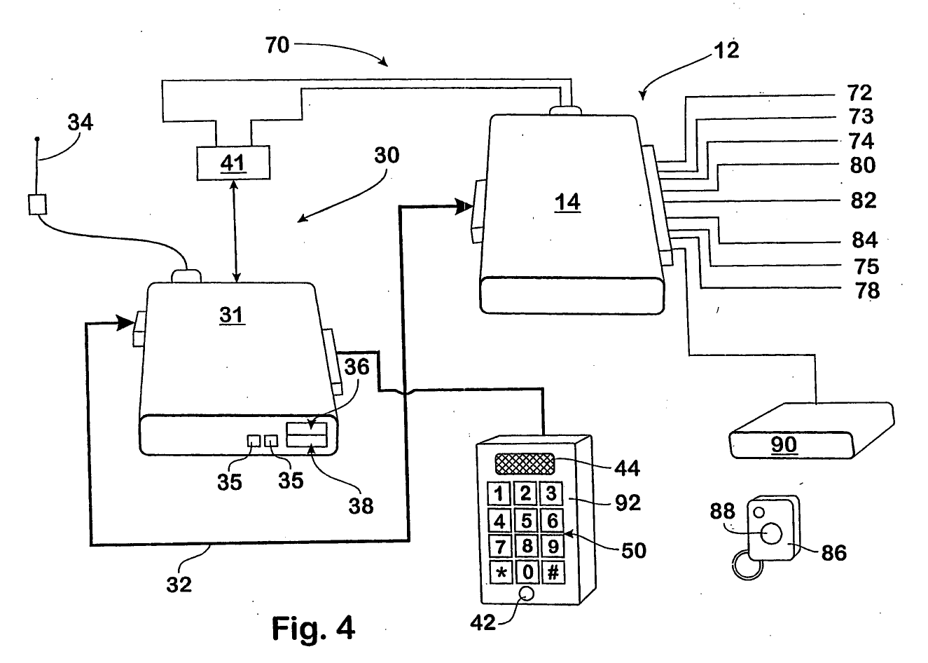

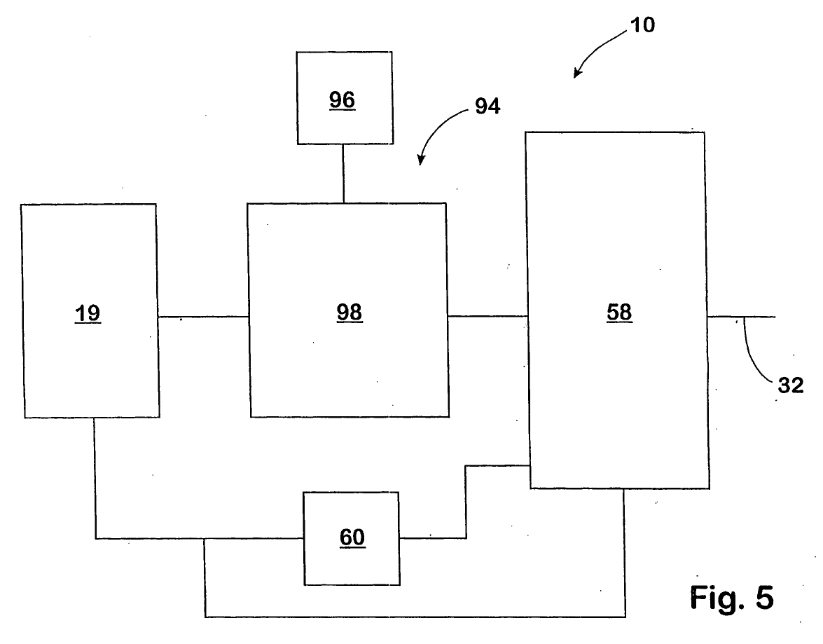

FIG. 5 shows a further embodiment of a vehicle security system 10 as described with reference to FIGS. 1 to 3, like reference numerals again indicating like parts. The system 10 includes a tracking system 94 comprising a global positioning system (GPS) antenna 96 and a GPS unit 98, the GPS unit 98 being connected to the CPU 58 of the vehicle.

In use, the tracking system 94 continuously tracks the position of the vehicle. When the alarm arrangement 12 generates an alarm signal, and an alarm message is sent to the user via the GSM network, the position of the vehicle is noted and the alarm message includes information about the location of the vehicle, preferably providing GPS co-ordinates of the vehicle's location.

It is an advantage of a security system as described with reference to the drawings, that it provides for emergency notification of a user on the mobile telephone of the user. This is not the case with conventional security systems of this kind, as the twin-call SIM-card in a conventional vehicle telephone system is usually identical to the twin-call SlM-card in the user's mobile telephone.

It is also an advantage of the vehicle security system of FIGS. 1 to 3 that the system is substantially obscured or hidden from view, so that it is not possible for a potential burglar to establish whether or not a particular vehicle is fitted with the security system by peering through windows of the vehicle. Furthermore, the telephone unit 31 can be used in a variety of applications, and can be sold as a unit for do-it-yourself retro-fit installation.

The applicant envisages that the control unit 31 can be used in other applications which are not related to security, such as a monitoring application in which the telephone control unit 31 is configured automatically to alert a user by means of a SMS-message when, for instance, predetermined values of performance variables of machinery located at a remote location are not met.

It will of course be realised that the above embodiments have been given only by way of illustrative example of the invention, and that all such modifications and variations thereto as would be apparent to persons skilled in the art are deemed to fall within the broad scope and ambit of the invention as is herein set forth in the following claims.

1. A mobile telephone device including:
a single transceiver for connecting the telephone device to a mobile telephone network; and
a controller coupled to the transceiver, the controller operative to place the mobile telephone device in at least one of:
a telephone condition thereby allowing a user to selectively connect to the mobile telephone network; and
in response to receiving an alarm signal, an alarm condition to connect the transceiver to the mobile telephone network and thereby notify a predetermined terminal of the receipt of the alarm signal.

2. A mobile telephone device according to claim 1 wherein the alarm signal is received in response to the detection of unauthorised activity in respect of a vehicle in which the mobile telephone device is installed.

3. A mobile telephone device according to claim 2 wherein a switch is arranged to place the mobile telephone device in the alarm condition in response to switching off of the vehicle and in the telephone condition in response to ignition of the vehicle.

4. A mobile telephone device according to claim 3 wherein the controller further includes means for diverting incoming communications received when the telephone device is in the alarm condition, to an answering service.

5. A mobile telephone device according to claim 2 wherein the mobile telephone device forms part of a mobile telephone for installation in the vehicle.

6. A mobile telephone according to claim 5 wherein the mobile telephone in the vehicle is substantially hidden from view.

7. A mobile telephone according to claim 5 further including a keypad that is operable between a hidden condition in which the keypad is hidden from view, and an operative position, in which the key pad is visible and is readily accessible to a driver of the vehicle.

8. A mobile telephone according to claim 5 further including a disconnectably connectable headset comprising a microphone-and-speaker system.

9. A mobile telephone according to claim 5 further including a speaker in the form of an ear-piece for location in an ear of a driver of the vehicle.

10. A mobile telephone according to claim 5 further including a dialup system for permitting a user to control the mobile telephone device by use of a mobile telephone handset, and to connect the handset to the mobile telephone network.

11. A mobile telephone according to claim 10 wherein the dial-up system includes a device for receiving audio signals from the handset, the audio signals being generated in response to the pressing of keys on a keypad of the handset, and for converting the audio signals to electronic command signals for the mobile telephone.

12. A mobile telephone according to claim 11 wherein the conversion of the audio signals is in accordance with standard protocols such as DTMF.

13. A mobile telephone according to claim 5 further including a cordless keypad for interfacing with the controller of the mobile telephone device via wireless communication signals, such as infra-red communication signals.

14. A mobile telephone device according to claim 1 wherein the transceiver includes means for providing a position signal indicative of the geographical position of the mobile telephone device.

15. A mobile telephone device according to claim 1 wherein the predetermined terminal is the user's mobile telephone.

16. A mobile telephone device according to claim 1 wherein the notification of the alarm signal is by way of a text message.

17. A mobile telephone device according to claim 1 wherein the notification is a voice call.

18. A mobile telephone device including:
a single transceiver for connecting the telephone device to a mobile telephone; and
a controller coupled to the transceiver, the controller operative to place the mobile telephone device in at least one of:
a telephone condition thereby allowing a user to selectively connect to the mobile telephone network; and
in response to receiving an alarm signal, an alarm condition to connect the transceiver to the mobile telephone network,
the controller having a security subscriber identification module for use in connection to the mobile telephone network when the mobile telephone device is in the alarm condition and a user subscriber identification module for use in connection to the mobile telephone network when the mobile telephone device is in the telephone condition.

19. A mobile telephone device according to claim 18 wherein the user subscriber identification module is one of a pair of subscriber identification modules both of which identify the same account with said account being a different account from that identified by the security subscriber identification module.

20. A mobile telephone device according to claim 19 wherein the user's mobile telephone operates with a twin-call SIM-card identifying the same account as the user SIM-card in the mobile telephone device.

21. A mobile telephone device according to claim 18 wherein the security subscriber identification module and the user subscriber identification module are SIM-cards.

22. A mobile telephone device according to claim 18 wherein the alarm signal is received in response to the detection of unauthorised activity in respect of a vehicle in which the mobile telephone device is installed.

23. A mobile telephone device according to claim 22 further including a switch arranged to place the mobile telephone device in the alarm condition by connecting the transceiver to the security SIM-card in response to switching off of the vehicle and in the telephone condition by connecting the transceiver to the user SIM-card in response to ignition of the vehicle.

24. A mobile telephone device according to claim 18 wherein the controller sends an alarm message to a predetermined terminal in response to receiving the alarm signal.

25. A mobile telephone device according to claim 24 wherein the alarm message is a text message.

26. A mobile telephone device according to claim 24 wherein the alarm message is a voice call.

27. A mobile telephone device according to claim 18 wherein the transceiver includes means for providing a position signal indicative of the geographical position of the mobile telephone device.

28. A mobile telephone device according to claim 22 wherein the mobile telephone device forms part of a mobile telephone for installation in the vehicle.

29. A mobile telephone according to claim 28 wherein the mobile telephone in the vehicle is substantially hidden from view.

30. A mobile telephone according to claim 29 further including a keypad that is operable between a hidden condition in which the keypad is hidden from view, and an operative position, in which the key pad is visible and is readily accessible to a driver of the vehicle.

31. A mobile telephone according to claim 30 further including a disconnectably connectable headset comprising a microphone-and-speaker system.

32. A mobile telephone according to claim 31 further including a speaker in the form of an ear-piece for location in an ear of a driver of the vehicle.

33. A mobile telephone according to claim 32 further including a dial-up system for permitting a user to control the telephone control unit by use of a mobile telephone handset, and to connect the mobile telephone to the telephone network.

34. A mobile telephone according to claim 33 wherein the dial-up system includes a device for receiving audio signals from a mobile telephone handset, the audio signals being generated in response to the pressing of keys on a keypad of the mobile telephone handset, and for converting the audio signals to electronic command signals for the mobile telephone.

36. A mobile telephone according to claim 34 wherein the conversion of the audio signals is in accordance with standard protocols such as DTMF.

36. A mobile telephone according to claim 28 further including a cordless keypad for interfacing with the control unit of the mobile telephone via wireless communication signals, such as infra-red communication signals.

37. A monitoring application including a mobile telephone device according to claim 1 wherein the alarm signal is received by the mobile telephone device when a predetermined value of a performance variable relating a process located at a remote location is not met.

38. A security system for protection of an area, the system including:
an alarm arrangement for detecting unauthorised activity in respect of the protected area and for generating an alarm signal in response to detection of the unauthorised activity; and
a mobile telephone device connected to the alarm arrangement, the mobile telephone device being operable in an alarm condition to connect to a mobile telephone network and notify a predetermined terminal of the generation of the alarm signal and in a telephone condition to allow a user to connect to the mobile telephone network.
